(19) United States
(12) Patent Application Publication
(10) Pub. No.: US 2021/0332911 A1
(43) Pub. Date: Oct. 28, 2021

(54) Electronic Valve, Valve Body Structure, Valve, Valve Core, and Integral Valve Core Structure of Electronic Valve

(71) Applicant: ZHEJIANG YINLUN MACHINERY CO., LTD., Zhejiang (CN)

(72) Inventor: Jun MA, Zhejiang (CN)

(73) Assignee: ZHEJIANG YINLUN MACHINERY CO., LTD.

(21) Appl. No.: 17/369,585

(22) Filed: Jul. 7, 2021

Related U.S. Application Data
(63) Continuation-in-part of application No. PCT/CN2019/126763, filed on Dec. 19, 2019.

(30) Foreign Application Priority Data
Jan. 7, 2019 (CN) 201910013349.1
Jan. 7, 2019 (CN) 201920024579.3
May 21, 2019 (CN) 201920734813.1

(51) Int. Cl. F16K 31/53; F16K 11/087; F16K 27/06; F16K 31/04; F16K 27/12

(52) U.S. Cl. CPC F16K 31/535; F16K 11/0873; F16K 27/12; F16K 31/041; F16K 27/06

(57) ABSTRACT

The present disclosure discloses an electronic valve, a valve body structure, a valve, a valve core, and an integrated valve core structure of an electronic valve. The electronic valve includes a valve body assembly, a flow control device, and a power device. The valve body assembly includes a valve body. The valve body includes an upper valve body portion and a lower valve body portion. The upper valve body portion is provided with an upper end cover. The lower valve body portion is provided with connecting pipes and a lower end cover. The power device is placed in a space defined by the upper end cover and the upper valve body portion. The flow control device is placed in a space defined by the lower end cover and the lower valve body portion. The upper valve body portion and the lower valve body portion are molded integrally by injection molding.

### CROSS-REFERENCE TO RELATED APPLICATIONS

This application is a continuation-in-part of PCT application no. PCT/CN2019/126763 filed on Dec. 19, 2019 which claims priority to Chinese Patent Application No. 201910013349.1, filed with the Chinese Patent Office on Jan. 7, 2019, entitled “Electronic Valve and Valve Body Structure thereof”, Chinese Patent Application No. 201920734813.1, filed with the Chinese Patent Office on May 21, 2019, entitled “Valve and Valve Core thereof”, and Chinese Patent Application No. 201920024579.3, filed with the Chinese Patent Office on Jan. 7, 2019, entitled “Integrated Valve Core Structure of Electronic Valve”, which are incorporated herein by reference in their entireties.

### TECHNICAL FIELD

The present disclosure relates to the technical field of new energy vehicles, in particular to the field of electronic valve products used in thermal management systems for new energy vehicles, and specifically to an electronic valve, a valve body structure, a valve, a valve core, and an integrated valve core structure (i.e. integral valve core structure) of an electronic valve in a water passage system for a vehicle.

### BACKGROUND ART

Pure electric vehicles and hybrid power vehicles use batteries as their power sources. The performance and quality of these vehicles depend to a large extent on the performance of the power battery packs equipped therein. Therefore, battery thermal management must be performed on the power batteries to keep their operating temperatures in a preferred range.

FIG. 1 shows a schematic diagram of a current liquid cooling and heating system for a new energy battery. A vehicular air conditioner consists of a compressor, a condenser, an expansion valve, and an evaporator which forms a refrigerant circuit. As thermal management of a battery is required in a new energy vehicle, generally a battery cryocooler is connected in parallel with the evaporator in the air conditioning circuit. A cooling liquid circuit is constituted by an electronic water pump, a low-temperature water tank, a battery cryocooler, a heater, and a water cooling plate. Heat generated during operation of the battery is transmitted to the water cooling plate and then to the cooling liquid. The media in the two circuits exchange heat in the battery cryocooler to cool down the battery. The electronic valve is used for controlling the flow direction and flow rate in the cooling liquid circuit.

A prior art electronic valve has the following deficiencies. The valve body is assembled from multiple components, is assembled complicatedly, and is manufactured at high cost, and there is poor coaxiality between the components, which will reduce the efficiency of power transmission and may also cause a jammed rotation, resulting in a failure of the electronic valve. It is necessary to provide corresponding molds for manufacturing the respective components, and the molds and components require high costs. When the multiple components are combined, poor sealing may easily occur at their contact parts, and the adjacent components should be sealed by sealing rings, which thus increases the number of components and cost of manufacture of the product.

### SUMMARY

The present disclosure is intended to solve at least one of the above technical problems existing in the prior art and aims at providing an electronic valve, a valve body structure, a valve, a valve core, and an integrated valve core structure of an electronic valve to solve the problem of cooperation of a flow control device and a power device while reducing the product cost.

The present disclosure includes the following technical solution. An electronic valve includes a valve body assembly, a flow control device, and a power device, wherein the valve body assembly includes a valve body, the valve body includes an upper valve body portion and a lower valve body portion, the upper valve body portion is provided with an upper end cover, and the lower valve body portion is provided with connecting pipes and a lower end cover; the power device includes a motor, a gear train, and a control board and is placed in a space defined by the upper end cover and the upper valve body portion; the flow control device includes a valve core and is placed in a space defined by the lower end cover and the lower valve body portion, and the upper valve body portion and the lower valve body portion are molded integrally by injection molding.

An electronic valve of the present disclosure has a proper structural design. The upper valve body portion and the lower valve body portion are integrated as an integrally molded piece, thus the number of components of the electronic valve product is reduced, and the process of assembling the upper valve body portion and the lower valve body portion is reduced. Also, the number of molds for the components of the product is reduced, the product development period is greatly shortened, and the product research and development costs are reduced. Moreover, the integrated electronic valve is molded integrally by molds, thus the product size can be ensured more easily, and the weight of the entire product can be reduced, and the goals of light-weighting and integration required by original equipment manufacturers can be achieved more easily.

Optionally, a valve body constriction portion (necking portion) is further provided between the upper valve body portion and the lower valve body portion, and first reinforcing ribs (also called reinforcing ribs) are provided on the valve body constriction portion, so that the strength of the valve body can be greatly improved without increasing the size and wall thickness of the valve body.

The structure and shape of the first reinforcing ribs are not limited, provided that it can achieve the purpose. Preferably, the first reinforcing ribs are provided radially around the core axis of the valve core, and the number of the first reinforcing ribs is preferably from 2 to 4. A plurality of first reinforcing ribs are arranged uniformly in the circumferential direction of the valve core constriction portion.

Optionally, an embedded metal member is further provided at the bottom of the lower valve body portion. Preferably, a mounting foot is further provided at the lower valve body portion, and the embedded metal member is embedded into the bottom of the mounting foot. The embedded metal member is used for mounting of the electronic valve of the present disclosure to a corresponding component of a vehicle. Unlike the prior art in which the mounting is performed from the side of the valve body, the present disclosure adopts mounting from the bottom surface, which not only allows easy operation, but also allows more proper utilization of the interior space of the vehicle. The embedded metal member is a nut or bolt structure, and two to four embedded metal members and corresponding mounting feet are preferable.

Optionally, the upper valve body portion has a power device receiving cavity, and at least one protruding ridge is provided on the side wall of the power device receiving cavity. Since the present disclosure adopts an integrated valve body structure, a partial weak region may be formed at the upper valve body portion during demolding, causing cracking of the plastic part. The at least one protruding ridge can increase the adhesion between the material and the mold during injection molding and plays a role of reinforcing, whereby the non-defective rate in de-molding can be increased.

Optionally, there are one or more protruding ridges, which are provided in the circumferential direction of the side wall of the power device receiving cavity. The protruding ridge(s) may be provided around the side wall of the power device receiving cavity and arranged in a closed manner or in multiple spaced sections.

Optionally, the protruding ridge is provided in parallel to the core axis of the valve core.

Optionally, both an annular protruding ridge(s) and an axial ridge(s) are provided on the inner wall of the upper valve body portion.

The height of the protruding ridge should not be excessive and is preferably less than 1 mm, in order to facilitate demolding. The demolding may be carried out by a forced demolding method without increasing the difficulty in the mold.

Optionally, a first sealing ring is provided between the valve core and the valve body to separate the flow control device receiving cavity in the lower valve body portion from the power device receiving cavity in the upper valve body portion. A second sealing ring groove is further provided above the first sealing ring, and the first sealing ring and the second sealing ring groove are spaced one above another in the axial direction of the valve core. After the electronic valve is used for a long time, particularly the valve core and the valve body cause relatively significant frictional erosion on the sealing surfaces. The frictionally eroded sealing ring may lead to unreliable sealing, and the cooling liquid in the valve body will leak out, thereby resulting in a failure of the electronic valve. When the first sealing ring can meet the sealing requirement, the second sealing ring groove is vacant. On the contrary, if the first sealing ring cannot guarantee the sealing performance of the electronic valve, a second sealing ring is placed in the second sealing ring groove. The use of double seals allows great enhancement of the sealing effect of the electronic valve and contributes to increased reliability and prolonged service life of the product. Since the present disclosure adopts an integrated valve body structure, there is no need to provide a sealing ring between the upper valve body portion and the lower valve body portion, and the overall sealing effect of the electronic valve is improved without increasing the number of sealing rings.

Optionally, the injection molding material used for the valve body includes, but is not limited to, a PA (Polyamide), PPA (Polyphthalamide), or PPS (Polyphenylene sulfide) material.

Optionally, in the present disclosure, the power device includes a motor, a gear train, and a control board. The motor may be a DC motor or a stepper motor. Gears in the gear train may be made of plastic or metal.

The present disclosure further provides a valve body structure of an electronic valve. The valve body includes an upper valve body portion and a lower valve body portion. The upper valve body portion is connected to an upper end cover, and the lower valve body portion is connected to a lower end cover and connecting pipes. The valve body is integrally molded by injection molding. A valve body constriction portion is further provided between the upper valve body portion and the lower valve body portion, and a set of first reinforcing ribs is provided on the constriction portion. An embedded metal member configured for mounting of an electronic valve is further provided at the bottom of the lower valve body portion. The upper valve body portion has a power device receiving cavity, and at least one protruding ridge is further provided on the side wall of the power device receiving cavity.

The present disclosure provides a valve core, including a valve core body and a transmission part molded integrally with the valve core body. The transmission part is provided coaxially with the valve core body, and the transmission part is configured to be engaged (fitted) with a driving member to drive the valve core to move.

Optionally, the valve core body has a connecting part, and the transmission part includes a plurality of gear teeth formed on the connecting part, so that a gear structure is formed by the gear teeth and the connecting part.

This technical solution has the following advantageous effects. This enables the transmission part to be formed directly on the valve core body while omitting a connecting shaft for connecting the valve core and the output gear, so that the overall formed by the valve core body and the transmission part has smaller volume, thereby reducing the space occupied by the valve core in the housing of the valve and providing sufficient mounting space for proper arrangement of other structures or components in the valve. Moreover, the size of the valve is correspondingly reduced to contribute to miniaturization of the product, whereby the valve core and the valve are fabricated with less material, and the manufacturing cost is reduced.

Optionally, the gear structure is a sector gear.

This technical solution has the following advantageous effects. The valve core generally only needs to rotate within a certain angle range to achieve the corresponding function during the use of the valve. Therefore, when the above-mentioned gear structure is provided as a sector gear, the normal function of the valve core can be ensured, and furthermore the transmission part can have a reduced volume and can be fabricated with less material, and hence the valve core and the valve can have a reduced volume and can be fabricated with less material. This not only contributes to the miniaturization of the product, but also reduces the manufacturing cost.

Optionally, a rotating shaft configured to be inserted into an external mounting portion is formed on the valve core body. The rotating shaft at least partially overlaps with the transmission part in a first direction, and an accommodating part configured to accommodate the external mounting portion is formed between the rotating shaft and the transmission part. The first direction is a radial direction of the valve core body.

This technical solution has the following advantageous effects. The above-mentioned at least partial overlap between the rotating shaft and the transmission part in the first direction includes both complete overlap and partial overlap between the rotating shaft and the transmission part in the first direction. If the rotating shaft at least partially overlaps with the transmission part in the first direction, both power transmission and fitting with the housing of the valve can be achieved at the same position in the axial direction of the valve core body. In this way, compared with the case in which the power transmission and fitting with the housing of the valve are achieved at two positions respectively in the axial direction of the valve core body, the space occupied by the valve core and the own structure of the valve core are effectively utilized. Not only the volume of the valve core, the fabrication materials, and the fabrication cost can be reduced, but also the volume and the cost of fabrication of the valve are reduced accordingly, which contributes to the miniaturization of the product. Moreover, with the use of the above-mentioned accommodating part for accommodating the external mounting portion, the external mounting portion, the rotating shaft, and the transmission part overlap in the first direction after the valve core is mounted in the above-mentioned housing. This further reduces the volume of the valve.

Optionally, the valve core includes a supporting rib located in the accommodating part and connected to the transmission part, so as to support the transmission part in the first direction.

This technical solution has the following advantageous effects. Because the transmission part bears a certain force in the first direction during power transmission, and because the accommodating part is formed between the rotating shaft and the transmission part, the portion at the connection position between the transmission part and the valve core body has a small area, and a fracture may occur at the connection position during use. With the use of the above-mentioned supporting rib, the transmission part is effectively supported in the first direction, whereby the probability of fracture at the above-mentioned connection position is reduced.

Optionally, the two ends of the valve core body in a second direction are a first end and a second end respectively, the transmission part is formed at the first end, a dustproof part is further formed on the valve core body, the dustproof part is located between the transmission part and the second end, and the second direction is an axial direction of the valve core body.

This technical solution has the following advantageous effects. Impurities can be intercepted by using the above-mentioned dustproof part when a medium flows toward the transmission part, thereby reducing or even avoiding entry of impurities into the transmission mechanism and between the transmission part and the transmission mechanism, avoiding the adverse influence of impurities on the power transmission, and prolonging the service life of the transmission part and the transmission mechanism.

Optionally, the dustproof part is an annular structure provided coaxially with the valve core body, and the dustproof part has an outer diameter larger than that of the valve core body.

This technical solution has the following advantageous effect. In this way, when the medium flows from the second end to the transmission part, the dustproof part can occupy a larger part of the medium flow path, so that the dustproof part can intercept the impurities in a better way.

Optionally, the dustproof part has a dustproof groove extending in the circumferential direction of the valve core body.

This technical solution has the following advantageous effects. In this way, not only the impurities in the medium can be blocked by the dustproof part, but also the impurities can be accommodated in the dustproof groove, thereby preventing the impurities from flowing toward the direction of the transmission part again, thereby more effectively avoiding entry of the impurities into the transmission mechanism and between the transmission mechanism and the transmission part, to provide a better dustproof function.

Optionally, the dustproof groove has a groove opening facing the outside of the valve core body in a first direction, and the first direction is a radial direction of the valve core body.

This technical solution includes the following advantageous effects. Since the impurities carried by the medium generally flow from the outer wall of the valve core body to the transmission part, the impurities can be better intercepted and stored in the dustproof groove, with the groove opening facing the outside of the valve core body in the first direction, thereby improving the dustproof effect.

The present disclosure further provides a valve, including the above-mentioned valve core according to the present disclosure.

The technical solutions according to the present disclosure include the following advantageous effects.

The valve and its valve core according to the present disclosure are fabricated by molding a valve core body integrally with a transmission part, thereby avoiding a process of assembling the valve core and the output gear while avoiding the problem of reduced power transmission efficiency due to a possible low coaxiality between the valve core and the output gear during the assembling. Moreover, the integral molding of the valve core body and the transmission part enables high coaxiality and hence high power-transmission efficiency. Furthermore, higher coaxiality is required between the valve core and the output gear in order to ensure higher power transmission efficiency, which leads to increased difficulty in assembling them and reduced production efficiency. The process of assembling the valve core with the output gear is omitted and the production efficiency is increased by molding the valve core body integrally with the transmission part. Also, if the valve core and the output gear have a large dimensional deviation during production, there will be such a problem that they may be assembled with difficulty or fitted un-tightly or easily loosened, which affects the torque of the gear. This problem is avoided by omitting the assembling process by molding the valve core body integrally with the transmission part. Moreover, because there is no fitting tolerance, the torque can be transmitted constantly, so that the valve has higher flow control accuracy. In addition, because the valve core body is to be molded integrally with the transmission part, only one mold is needed for production, and the production cost is reduced due to the relatively simple mold structure.

The present disclosure further provides an integrated valve core body structure of an electronic valve, which includes a valve core body and a gear structure. The valve core body and the gear structure are integrally molded.

The integrated valve core body structure of the electronic valve of the present disclosure has at least the following advantageous effects because the valve core body and the gear structure are structurally integrated.

1. The coaxiality of the valve core body and the gear structure can be ensured, so that there is no power loss during power transmission, and the power is transmitted with high efficiency.

2. Because the valve core body and the gear structure are structurally integrated, there is no fitting tolerance, so that torque from the gear structure can be transmitted constantly, and high flow control accuracy is obtained.

3. Because the valve core body and the gear structure are structurally integrated, only one mold is required, and the mold is relatively simple and the mold cost is low.

4. Because the valve core body and the gear structure are structurally integrated, a connecting section between the upper part of the valve core body and the gear structure can be omitted. Thus, their overall size is small, and the height of the valve core body and the gear structure can be reduced to achieve a smaller overall size of the electronic valve. This contributes to the miniaturization of the product and enables less mounting space while reducing the amount of materials to be used and reducing the manufacturing cost.

Optionally, an annular groove configured for placement of a sealing ring therein is further provided at the top of the valve core body, so that the upper and lower chambers of the valve body are sealed and isolated from each other, and the fluid medium in the lower chamber will not leak to the upper chamber.

Optionally, second reinforcing rib(s) (also called a reinforcing rib) is provided on the gear structure. The second reinforcing rib is provided radially, and a plurality of second reinforcing ribs are uniformly arranged in the circumferential direction of the gear structure.

Optionally, an upper mounting shaft configured to connect the integrated valve core body to the upper valve body portion and/or to the upper end cover is provided at the top of the gear structure.

Optionally, a lower mounting shaft configured to connect the integrated valve core body to the lower valve body portion and/or to the lower end cover is further provided at the bottom of the valve core body.

Optionally, at least one protruding rib is further provided at the bottom end surface of the lower mounting shaft. A fit with a small area is created between the at least one protruding rib and the lower valve body portion and/or the lower end cover, thereby reducing rotational friction. Preferably, the at least one protruding rib has a semicircular section. In this way, a linear fit is created between the at least one protruding rib and the lower valve body portion and/or the lower end cover, resulting in a smaller rotational friction force.

The protruding rib may be a ring-shaped rib, or two or more protruding ribs may be used, and the two or more protruding ribs are distributed in a ring shape.

Optionally, the integrated valve core body is further provided with a central through hole. The central through hole is fitted with a positioning shaft provided on the valve body, so that the integrated valve core body is mounted to the valve body more reliably and positioned more accurately.

### BRIEF DESCRIPTION OF THE DRAWINGS

The present disclosure will be further described below with reference to the accompanying drawings and embodiments.

FIG. 1 is a schematic circuit diagram of a liquid cooling and heating system for a new energy battery;

FIG. 2 is an exploded view of an electronic valve of the present disclosure;

FIG. 3 is an exploded view of a valve body structure of an electronic valve of the present disclosure;

FIG. 4 is a perspective view of a valve body structure of an electronic valve of the present disclosure;

FIG. 5 is a schematic structural view of the bottom of a valve body of an electronic valve of the present disclosure;

FIG. 6 is a schematic structural view of an embodiment of an electronic valve with a circumferential protruding ridge structure according to the present disclosure;

FIG. 7 is an enlarged view of portion A in FIG. 6;

FIG. 8 is a schematic structural view of an embodiment of an electronic valve with an axial protruding ridge structure according to the present disclosure;

FIG. 9 is an enlarged view of portion B in FIG. 8;

FIG. 10 is a schematic structural view of an embodiment of a dual-sealing structure of an electronic valve of the present disclosure;

FIG. 11 is a schematic structural perspective view of an implementation of a valve core according to an embodiment of the present disclosure;

FIG. 12 is a schematic structural front view of an implementation of a valve core according to an embodiment of the present disclosure;

FIG. 13 is a schematic structural view of an integrated valve core structure of the present disclosure;

FIG. 14 is a longitudinal sectional view of an integrated valve core structure of the present disclosure;

FIG. 15 is a top view of the integrated valve core structure in FIG. 14;

FIG. 16 is a schematic structural view of another embodiment of an integrated valve core of the present disclosure; and

FIG. 17 is a longitudinal sectional view of the integrated valve core of the embodiment in FIG. 16.

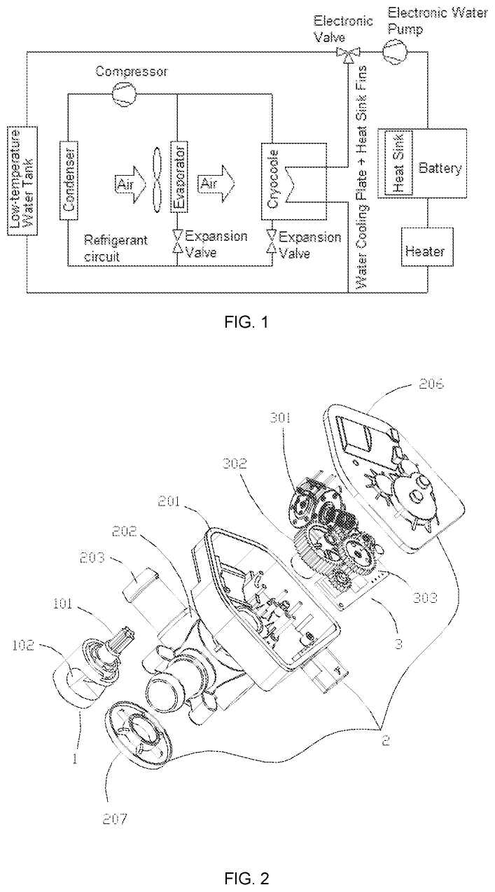

In the figures, 1: flow control device; 2: valve body assembly; 3: power device; 4: first sealing ring; 5: second sealing ring groove; 101: valve core; 102: flow channel; 201: upper valve body portion; 202: lower valve body portion; 203: connecting pipe; 204: valve body constriction portion; 205: first reinforcing rib; 206: upper end cover; 207: lower end cover; 208: shock-absorbing pad; 209: embedded metal member; 210: protruding ridge; 211: protruding ring; 212: mounting foot; 213: connecting port; 214: power device receiving cavity; 215: side wall of power device receiving cavity; 301: motor; 302: gear train; 303: control board;

100: valve core body; 110: first end; 120: second end; 130: connecting part; 200: rotating shaft; 300: dustproof part; 310: dustproof groove; 400: supporting rib; 500: accommodating part; 600: gear teeth;

103: gear structure; 6: upper mounting shaft; 7: annular groove; 9: lower mounting shaft; 10: protruding rib; 11: lower mounting shaft end surface; 12: second reinforcing rib; 13: central through hole.

### DETAILED DESCRIPTION OF THE EMBODIMENTS

In the description of the present disclosure, the terms such as “up”, “down”, “left”, “right”, “top”, and “bottom” indicate the orientation or positional relationships shown based on the figures, and are intended only to facilitate the description of the present disclosure and simplify the description, but not intended to indicate or imply that the referred devices or elements must be in a particular orientation or constructed or operated in the particular orientation, and therefore should not be construed as limiting the present disclosure.

Referring to FIG. 2, an electronic valve of the present disclosure includes a valve body assembly 2, a flow control device 1, and a power device 3. The valve body assembly 2 includes a valve body. The valve body includes an upper valve body portion 201 and a lower valve body portion 202. The upper valve body portion 201 is provided with an upper end cover 206. The lower valve body portion 202 is provided with connecting pipes 203 and a lower end cover 207. The power device 3 includes a motor 301, a gear train 302, and a control board 303 and is placed in the space defined by the upper end cover 206 and the upper valve body portion 201. The flow control device 1 includes a valve core 101. A flow channel 102 is provided in the valve core 101. The valve core 101 is placed in the space defined by the lower end cover 207 and the lower valve body portion 202.

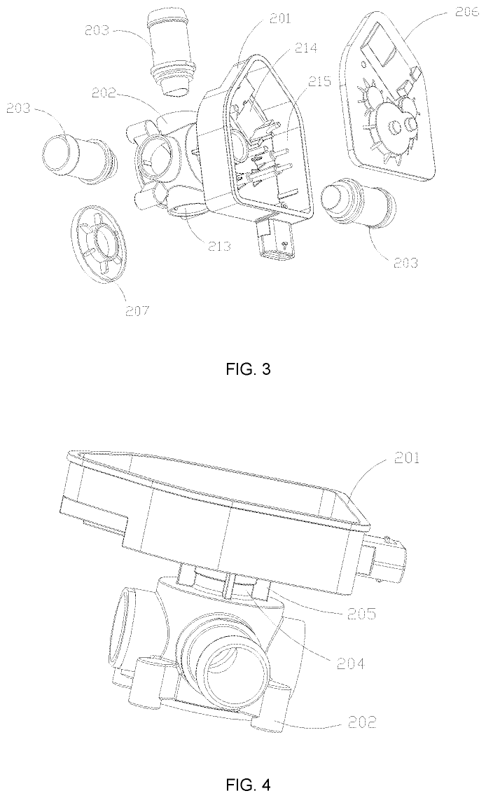

Referring to FIG. 3, the upper valve body portion 201 and the lower valve body portion 202 are integrally molded by injection molding. The connecting pipe 203 is welded to a cooling liquid channel of the lower valve body portion 202 by ultrasonic or laser welding. There are no less than two connecting pipes 203, depending on the function and design requirements of the product. It is also possible to provide a plurality of connecting ports 213 in the lower valve body portion 202. When the number of the connecting pipes 203 is less than the number of the connecting ports 213, the unused connecting ports 213 are blocked with plugs, so that the valve body can be designed as a universal module.

Referring to FIG. 4, a valve body constriction portion (necking portion) 204 is further provided between the upper valve body portion 201 and the lower valve body portion 202, and first reinforcing ribs (also called reinforcing ribs) 205 are provided on the valve body constriction portion 204, so that the strength of the valve body can be greatly improved without increasing the size and wall thickness of the valve body. The structure and shape of the first reinforcing rib 205 are not limited, provided that it can achieve the desired purpose. Preferably, the first reinforcing ribs 205 are provided radially with the core axis of the valve core as the center, and the number of the first reinforcing ribs 205 is preferably from 2 to 4. In this embodiment, there are four first reinforcing ribs 205, which are arranged uniformly radially in the circumferential direction of the valve body constriction portion 204.

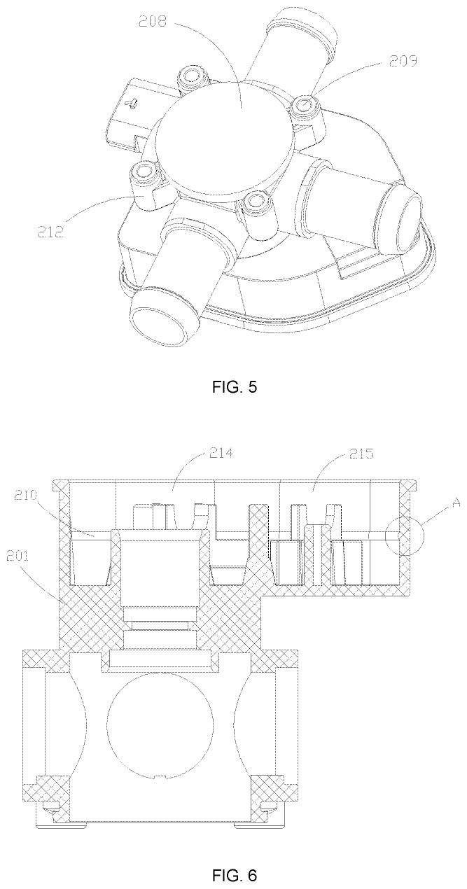

Referring to FIG. 5, embedded metal members 209 are further provided at the bottom of the lower valve body portion 202. Preferably, mounting feet 212 are further provided at the lower valve body portion 202, and each of the embedded metal members 209 is embedded into the bottom of the corresponding mounting foot 212. The embedded metal members 209 are used for mounting of the electronic valve of the present disclosure to a corresponding component of a vehicle. Unlike the prior art in which the mounting is performed from the side of the valve body, the present disclosure adopts mounting from the bottom surface, which not only allows easy operation, but also allows more proper utilization of the interior space of the vehicle. Optionally, the embedded metal member 209 may be a nut or bolt structure, and two to four embedded metal members 209 and corresponding mounting feet are preferable. In this embodiment, there are four embedded metal members 209. A shock-absorbing pad 208 may be further provided at the bottom of the lower valve body portion 202. The shock-absorbing pad 208 is of a ring-shaped structure. The material used for the shock-absorbing pad 208 includes, but is not limited to, EPDM (Ethylene Propylene Diene Monomer) rubber.

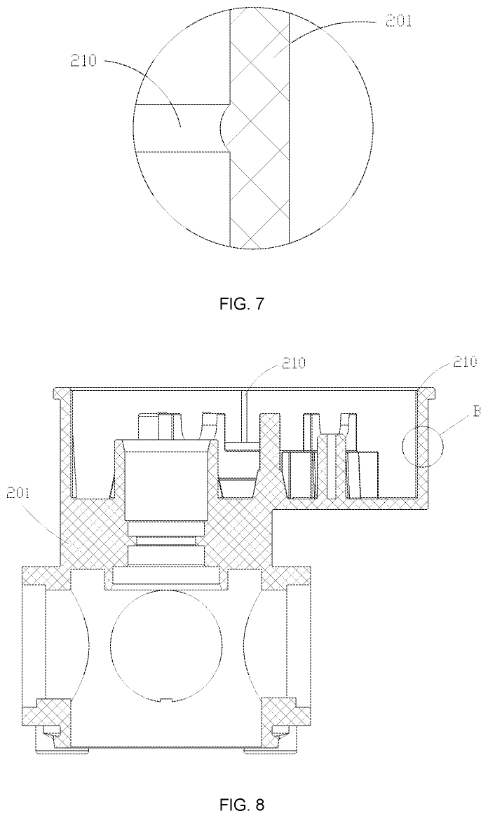

Referring to FIGS. 6 and 7, the upper valve body portion 201 has a power device receiving cavity 214 configured to receive the power device 3, and a protruding ridge 210 is further provided on the side wall of the power device receiving cavity 214. Since the present disclosure adopts an integrated valve body structure, a partial weak region may be formed at the upper valve body portion during demolding, causing cracking of the plastic part. The protruding ridge 210 can increase the adhesion between the material and the mold during injection molding and plays a role of reinforcing, whereby the non-defective rate in demolding can be increased.

Optionally, there may be one or more protruding ridges 210, which are provided in the circumferential direction of the side wall 215 of the power device receiving cavity. The protruding ridge(s) 210 may be provided around the side wall of the power device receiving cavity 214 and arranged in a closed manner or in multiple spaced sections.

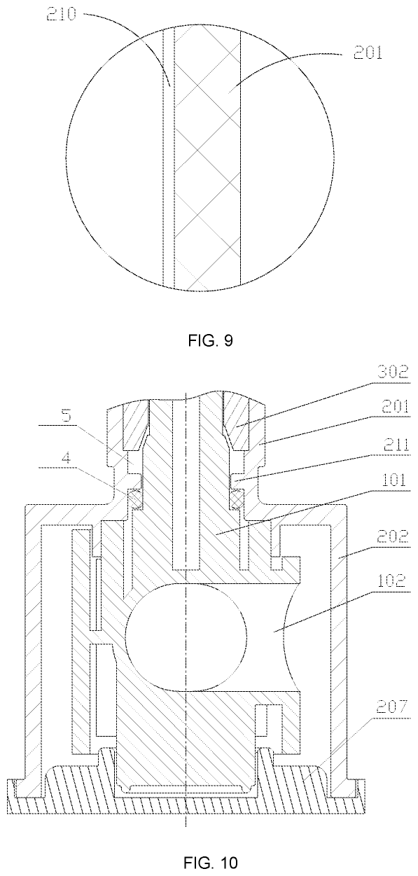

Referring to FIGS. 8 and 9, another arrangement of the protruding ridge 210 is shown. In this embodiment, the protruding ridge 210 may be arranged in parallel to the core axis of the valve core 101. There may be one or more protruding ridges 210. Preferably, a plurality of protruding ridges 210 are evenly distributed on the side wall of the power device receiving cavity 214 in the circumferential direction.

In another alternative manner, both an annular protruding ridge(s) and an axial ridge(s) are provided on the side wall 215 of the power device receiving cavity.

The height of the protruding ridge should not be excessive and is preferably less than 1 mm, in order to facilitate demolding. In this embodiment, the height of the protruding ridge may be 0.8 mm.

Referring to FIG. 10, a first sealing ring 4 and a second sealing ring groove 5 are provided between the valve core 101 and the upper valve body portion 202. The first sealing ring 4 and the second sealing ring groove 5 are spaced one above another in the axial direction of the valve core. When the first sealing ring 4 cannot guarantee the sealing performance of the electronic valve, a second sealing ring is placed in the second sealing ring groove 5. The use of double seals allows great enhancement of the sealing effect of the electronic valve and contributes to increased reliability and prolonged service life of the product. Since the present disclosure adopts an integrated valve body structure, there is no need to provide a sealing ring between the upper valve body portion 201 and the lower valve body portion 202, and the overall sealing effect of the electronic valve is improved without increasing the number of sealing rings. Optionally, as shown in FIG. 10, a protruding ring 211 may be provided on the interior of the upper valve body portion 202 in its circumferential direction, and a first sealing ring groove for receiving the first sealing ring 4 is formed between the lower region of the protruding ring 211 and the outer wall of the valve core 101. The above-mentioned sealing ring groove 5 is formed between the upper region of the protruding ring 211 and the outer wall of the valve core 101.

The injection molding material used for the valve body includes, but is not limited to, a PA, PPA, or PPS material. The motor of the power device may be a DC motor or a stepper motor. Gears in the gear train may be made of plastic or metal, and the number of the gears is not less than 2.

The electronic valve according to the present disclosure has a reasonable structural design. The upper valve body portion and the lower valve body portion are integrated as an integrally molded piece, thus the number of components of the electronic valve product is reduced, and the process of assembling the upper valve body portion and the lower valve body portion is omitted. Also, the number of molds for the components of the product is reduced, the product development period is greatly shortened, and the product research and development costs are reduced. Moreover, the integrated electronic valve is molded integrally by molds, thus the product size can be ensured more easily, and the weight of the entire product can be reduced, and the goals of light-weighting and integration required by original equipment manufacturers can be achieved more easily.

It should be understood that the above embodiments are merely illustrative of the present disclosure and are not intended to limit the present disclosure, and any inventive creations that do not depart from the scope of the essence and spirit of the present disclosure will fall within the scope of the present disclosure as claimed.

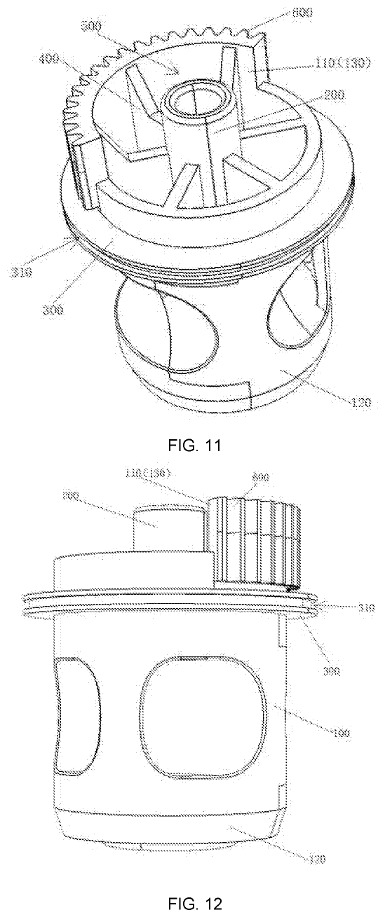

As shown in FIGS. 11 and 12, the present disclosure further provides a valve core, which includes a valve core body 100 and a transmission part molded integrally with the valve core body 100. The transmission part is provided coaxially with the valve core body 100, and the transmission part is configured to be engaged (fitted) with a driving member to drive the valve core to move.

The valve core according to the present disclosure is mounted in the valve housing when in use. The transmission part may be directly fitted with the driving member, or indirectly fitted with the driving member by means of a transmission mechanism.

The valve core according to the present disclosure is fabricated by molding a valve core body 100 integrally with a transmission part, thereby avoiding a process of assembling the valve core and the output gear while avoiding the problem of reduced power transmission efficiency due to a possible low coaxiality between the valve core and the output gear during the assembling. Moreover, the integral molding of the valve core body 100 and the transmission part enables high coaxiality and hence high power-transmission efficiency. Furthermore, higher coaxiality is required between the valve core and the output gear in order to ensure higher power transmission efficiency, which leads to increased difficulty in assembling them and reduced production efficiency. The process of assembling the valve core with the output gear is omitted and the production efficiency is increased by molding the valve core body 100 integrally with the transmission part. Also, if the valve core and the output gear have a large dimensional deviation during production, there will be such a problem that they may be assembled with difficulty or fitted un-tightly or easily loosened, which affects the torque of the gear. This problem is avoided by omitting the assembling process by molding the valve core body 100 integrally with the transmission part. Moreover, because there is no fitting tolerance, the torque can be transmitted constantly, so that the valve has a higher flow control accuracy. In addition, because the valve core body 100 is to be molded integrally with the transmission part, only one mold is needed for production, and the production cost is reduced due to the relatively simple mold structure.

Optionally, the valve core body 100 has a connecting part 130, and the transmission part includes a plurality of gear teeth 600 formed on the connecting part 130, so that a gear structure is formed by the gear teeth 600 and the connecting part 130. This enables the transmission part to be molded directly on the valve core body 100 while omitting a connecting shaft for connecting the valve core and the output gear, so that the overall formed by the valve core body 100 and the transmission part has smaller volume, thereby reducing the space occupied by the valve core in the housing of the valve and providing sufficient mounting space for reasonable arrangement of other structures or components in the valve. Moreover, the size of the valve is correspondingly reduced to contribute to miniaturization of the product, whereby the valve core and the valve are fabricated with less material, and the manufacturing cost is reduced. The specific number of the above-mentioned gear teeth 600 is not limited, as long as transmission of power by the transmission part can be ensured. For example, there may be more than ten, for example, fifteen, sixteen, or twenty gear teeth 600. Of course, the gear teeth 600 may not be directly molded on the connecting part 130, but the transmission part may further include a transition layer. The transition layer is molded on the connecting part 130, and the gear teeth 600 are molded on the transition layer, thereby increasing the thickness and strength of the entire gear structure. Of course, the transmission part itself may be provided as a gear structure and connected to the valve core body 100 by means of the connecting part 130, and the transmission part, the valve core body 100, and the connecting part 130 may be integrally molded.

Optionally, the gear structure is a sector gear. The valve core generally only needs to rotate within a certain angle range to achieve the corresponding function during the use of the valve. Therefore, when the above-mentioned gear structure is provided as a sector gear, the normal function of the valve core can be ensured, and furthermore the transmission part can have a reduced volume and can be fabricated with less material, and hence the valve core and the valve can have a reduced volume and can be fabricated with less material. This not only contributes to the miniaturization of the product, but also reduces the manufacturing cost. The central angle of the above-mentioned sector gear is preferably greater than or equal to 45 degrees and less than 360 degrees. The central angle of the above-mentioned sector gear is further preferably 120 degrees.

In an embodiment of the present disclosure, a rotating shaft 200 configured to be inserted into an external mounting portion is formed on the valve core body 100. The rotating shaft 200 at least partially overlaps with the transmission part in a first direction, and as shown in FIG. 11, an accommodating part 500 configured to accommodate the external mounting portion is formed between the rotating shaft 200 and the transmission part, and the first direction is the radial direction of the valve core body 100. The above-mentioned external mounting portion is a part of the housing of the valve. After the rotating shaft 200 is inserted into the external mounting portion, the valve core can rotate about the rotating shaft 200. The above-mentioned at least partial overlap between the rotating shaft 200 and the transmission part in the first direction includes both complete overlap and partial overlap between the rotating shaft 200 and the transmission part in the first direction. If the rotating shaft 200 at least partially overlaps with the transmission part in the first direction, both power transmission and fitting with the housing of the valve can be achieved at the same position in the axial direction of the valve core body 100. In this way, compared with case in which the power transmission and fitting with the housing of the valve are achieved at two positions respectively in the axial direction of the valve core body 100, the space occupied by the valve core and the structure of the valve core are effectively utilized. Not only the volume of the valve core, the fabrication materials, and the fabrication cost can be reduced, but also the volume and the cost of fabrication of the valve are reduced accordingly, which contributes to the miniaturization of the product. Moreover, with the use of the above-mentioned accommodating part 500 for accommodating the external mounting portion, the external mounting portion, the rotating shaft 200, and the transmission part overlap in the first direction after the valve core is mounted in the above-mentioned housing. This further reduces the volume of the valve. When the transmission part includes a plurality of gear teeth 600 formed on the above-mentioned connecting part 130, and a gear structure is formed by the connecting part 130 and the gear teeth 600, the above-mentioned accommodating part 500 may be formed between the connecting part 130 and the rotating shaft 200.

Optionally, the valve core may include a supporting rib 400 located in the accommodating part 500 and connected to the transmission part to support the transmission part in the first direction. Because the transmission part bears a certain force in the first direction during power transmission, and because the accommodating part 500 is formed between the rotating shaft 200 and the transmission part, the portion at the connection position between the transmission part and the valve core body 100 has a small area, and a fracture may occur at the connection position during use. With the use of the above-mentioned supporting rib 400, the transmission part is effectively supported in the first direction, whereby the probability of fracture at the above-mentioned connection position is reduced. When the transmission part includes a plurality of gear teeth 600 formed on the above-mentioned connecting part 130, and a gear structure is formed by the connecting part 130 and the gear teeth 600, the supporting rib 400 may be connected indirectly to the transmission part by being connected to the above-mentioned connecting part 130.

Optionally, the two ends of the valve core body 100 in a second direction are a first end 110 and a second end 120, respectively. The transmission part is formed at the first end 110. A dustproof part 300 is further formed on the valve core body 100. The dustproof part 300 is located between the transmission part and the second end 120. The second direction is the axial direction of the valve core body 100. After the valve core is mounted in the above-mentioned housing, the transmission part and the second end 120 are located in two chambers communicating with each other, respectively. The transmission part is fitted with the transmission mechanism, and the second end 120 is fitted with the housing to act on a medium to achieve the corresponding function of the valve. Since the above-mentioned two chambers communicate with each other, the medium will also flow into the chamber where the transmission mechanism is located. This makes it easy for impurities in the medium to enter between the transmission part and the transmission mechanism and enter the inside of the transmission mechanism, thereby adversely affecting the power transmission efficiency and the service life of the transmission part and the transmission mechanism. The impurities can be intercepted by using the above-mentioned dustproof part 300 when the medium flows toward the transmission part, thereby reducing or even avoiding entry of impurities into the transmission mechanism and between the transmission part and the transmission mechanism, avoiding the adverse influence of impurities on the power transmission, and prolonging the service life of the transmission part and the transmission mechanism. When the transmission part includes a plurality of gear teeth 600 formed on the connecting part 130, and a gear structure is formed by the connecting part 130 and the gear teeth 600, the connecting part 130 may be the first end 110 described above.

Optionally, the dustproof part 300 is an annular structure provided coaxially with the valve core body 100, and the outer diameter of the dustproof part 300 is larger than the outer diameter of the valve core body 100. In this way, when the medium flows from the second end 120 to the transmission part, the dustproof part 300 can occupy a larger part of the medium flow path, so that the dustproof part 300 can intercept the impurities in a better way. Of course, the dustproof part 300 may be formed by a plurality of strip-shaped structures spaced apart in the circumferential direction of the valve core body 100.

In an embodiment of the present disclosure, the dustproof part 300 has a dustproof groove 310 extending in the circumferential direction of the valve core body 100. In this way, not only the impurities in the medium can be blocked by the dustproof part 300, but also the impurities can be accommodated in the dustproof groove 310, thereby preventing the impurities from flowing toward the direction of the transmission part again, thereby more effectively avoiding entry of the impurities into the transmission mechanism and between the transmission mechanism and the transmission part, to provide a better dustproof function.

Optionally, the dustproof groove 310 has a groove opening facing the outside of the valve core body 100 in a first direction, and the first direction is the radial direction of the valve core body 100. Since the impurities carried by the medium generally flow from the outer wall of the valve core body 100 to the transmission part, the impurities can be better intercepted and stored in the dustproof groove 310, with the groove opening facing the outside of the valve core body 100 in the first direction, thereby improving the dustproof effect. Of course, the groove opening of the dustproof groove 310 may be oriented obliquely relative to the first direction.

The present disclosure further provides a valve including the valve core according to the above embodiment of the present disclosure.

The valve according to the present disclosure is fabricated by molding a valve core body 100 integrally with a transmission part, thereby avoiding a process of assembling the valve core and the output gear while avoiding the problem of reduced power transmission efficiency due to a possible low coaxiality between the valve core and the output gear during the assembling. Moreover, the integral molding of the valve core body 100 and the transmission part enables high coaxiality and hence high power-transmission efficiency. Furthermore, higher coaxiality is required between the valve core and the output gear in order to ensure higher power transmission efficiency, which leads to increased difficulty in assembling them and reduced production efficiency. The process of assembling the valve core with the output gear is eliminated and the production efficiency is increased by molding the valve core body 100 integrally with the transmission part. Also, if the valve core and the output gear have a large dimensional deviation during production, there will be such a problem that they may be assembled with difficulty or fitted untightly or easily loosened, which affects the torque of the gear. This problem is avoided by eliminating the assembling process by molding the valve core body 100 integrally with the transmission part. Moreover, because there is no fitting tolerance, the torque can be transmitted constantly, so that the valve has higher flow control accuracy. In addition, because the valve core body 100 is to be molded integrally with the transmission part, only one mold is needed for production, and the production cost is reduced due to the relatively simple mold structure.

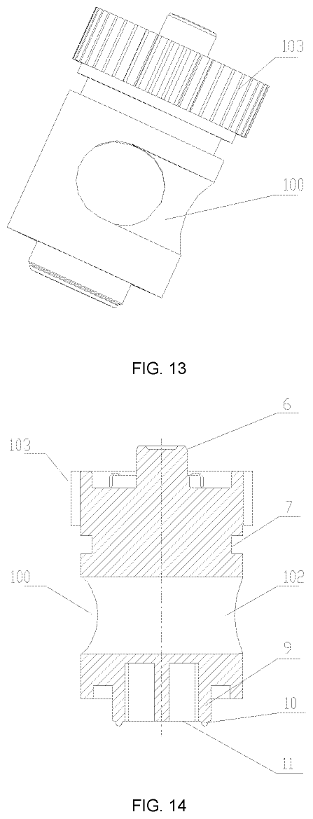

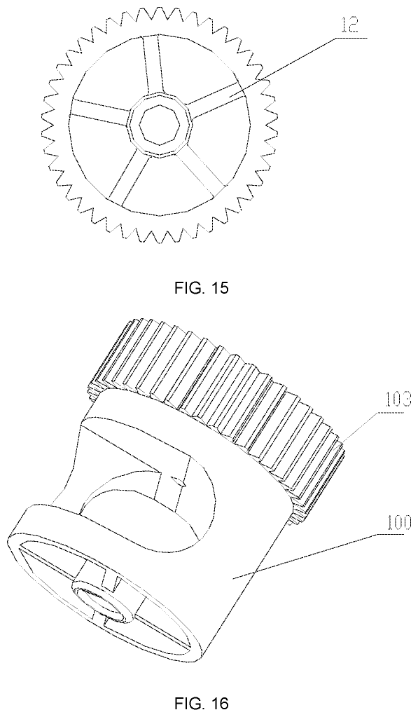

Referring to FIGS. 13, 14, and 15, an integrated valve core body structure of an electronic valve of the present disclosure includes a valve core body (also called a valve core) 100 and a gear structure (also called an output gear) 103. The valve core body 100 and the gear structure 103 are integrally molded.

A flow channel 102 is provided in the valve core body 100. The power device receives a control signal and then controls the rotation of the motor, and transmits power to the valve core body 100 by means of the gear train. When the valve core body 100 is rotated, the flow channel 102 in the valve core body is angularly changed, and its relative position relative to the outlet in the valve body also changes accordingly. When the flow channel 102 in the valve core body 100 is not in communication with the outlet in the valve body, the electronic valve is in a closed state. When the flow channel 102 in the valve core body 100 is in communication with the outlet in the valve body, the electronic valve is in an open state. As the area of the flow channel 102 in the valve core body 100 in communication with the outlet in the valve body increases, the rate of flow through the electronic valve increases accordingly. When the flow channel 102 in the valve core body is in full communication with the outlet in the valve body, the electronic valve is in the maximum flow state.

The gear structure 103 is the final-stage gear of the gear train of the power plant. The gear train has at least two gears. The number of the gears in the gear train is designed according to the required speed ratio.

The integrated valve core body structure of the electronic valve of the present disclosure is characterized by including a valve core body and a gear structure structurally integrated with each other. Such structure can ensure the coaxiality, so that there is no power loss during power transmission, and the power is transmitted with high efficiency.

Because the valve core body 100 and the gear structure 103 are structurally integrated, there is no fitting tolerance therebetween, so that torque from the gear structure 103 can be transmitted constantly, and high flow control accuracy is obtained.

Because the valve core body 100 and the gear structure 103 are structurally integrated, only one mold is required, and the mold is relatively simple and the mold cost is relatively low.

Because the valve core body 100 and the gear structure 103 are structurally integrated, there is no need to provide the upper part of the valve core body with a section to be connected to the gear structure 103. Thus, the height of the valve core body 100 and the gear structure 103 can be reduced to achieve a smaller overall size of the electronic valve. This contributes to the miniaturization of the product and allows for less mounting space while reducing the amount of materials to be used and reducing the manufacturing cost.

The valve core body 100 may be of any standard structure, such as a cylindrical or spherical structure. Optionally, the valve core body 100 may be of a cylindrical structure.

An annular groove 7 configured for placement of a sealing ring therein is further provided in the top of the valve core body 100, so that the upper and lower chambers of the valve body are sealed and isolated from each other, and the fluid medium in the lower chamber will not leak to the upper chamber.

A set of second reinforcing ribs 12 is further provided on the gear structure 103. The second reinforcing ribs are provided radially. The plurality of second reinforcing ribs 12 are uniformly arranged in the circumferential direction.

An upper mounting shaft 6 configured to connect the integrated valve core body to the upper valve body portion and/or to the upper end cover is provided at the top of the gear structure 103.

A lower mounting shaft 9 configured to connect the integrated valve core body to the lower valve body portion and/or to the lower end cover is further provided at the bottom of the valve core body 103.

A protruding rib 10 is further provided on the bottom end surface of the lower mounting shaft 9. A fit with a small area is created between the protruding rib 10 and the lower valve body portion and/or the lower end cover, thereby reducing rotational friction. Preferably, the protruding rib 10 has a semicircular section. In this way, a linear fit is created between the protruding rib 10 and the lower valve body portion and/or the lower end cover, resulting in a smaller rotational friction force.

The protruding rib 10 may be a ring-shaped rib, or two or more protruding ribs may be used, and the two or more protruding ribs are distributed in a ring shape.

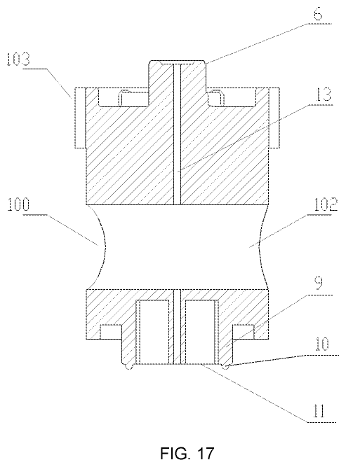

Referring to FIGS. 16 and 17, another embodiment of an integrated valve core body of the present disclosure is shown. In some electronic valves, other manners are used to prevent the fluid medium from leaking into a stationary component of the power device at the upper valve body portion. In this case, there is no need to provide an annular groove 7 for placement of a sealing ring in the valve core body 100.

In this embodiment, the integrated valve core body is further provided with a central through hole 13. The central through hole 13 is fitted with (matches) a positioning shaft provided on the valve body, so that the integrated valve core body is mounted to the valve body more reliably and positioned more accurately.

It should be understood that the above embodiments are merely illustrative of the present disclosure and are not intended to limit the present disclosure, and any inventive creations that do not depart from the scope of the essence and spirit of the present disclosure will fall within the scope of the present disclosure as claimed.

### INDUSTRIAL APPLICABILITY

The embodiments provide an electronic valve, a valve body structure, a valve, a valve core, and an integrated valve core structure of an electronic valve. The upper valve body portion and the lower valve body portion of the valve body are integrally molded by injection molding, so that the valve body has a small number of components and the two are connected with great firmness and high accuracy. Accordingly, a small number of molds are provided during machining and low machining cost is required.

What is claimed is:

1. An electronic valve, comprising a valve body assembly, a flow control device, and a power device, the valve body assembly comprising an upper end cover, a valve body, and a lower end cover, the valve body comprising an upper valve body portion and a lower valve body portion, the upper valve body portion being connected to the upper end cover, the lower valve body portion being connected to the lower end cover and provided with connecting pipes, the power device comprising a motor, a gear train, and a control board and being provided in a space defined by the upper end cover and the upper valve body portion, the flow control device comprising a valve core and being provided in a space defined by the lower end cover and the lower valve body portion, wherein the valve body is formed as an integral member by injection molding.

2. The electronic valve according to claim 1, wherein a constriction portion is provided between the upper valve body portion and the lower valve body portion, and a set of reinforcing ribs is provided on the constriction portion.

3. The electronic valve according to claim 1, wherein a bottom of the lower valve body portion is provided with embedded metal members configured for mounting of the electronic valve.

4. The electronic valve according to claim 3, wherein mounting feet are provided on the lower valve body portion, and each of the embedded metal members is embedded into a bottom of the corresponding mounting foot.

5. The electronic valve according to claim 1, wherein the upper valve body portion has a power device receiving cavity, and at least one protruding ridge is provided on a side wall of the power device receiving cavity.

6. The electronic valve according to claim 1, wherein the valve core of the flow control device comprises a valve core body and a transmission part molded integrally with the valve core body, the transmission part is provided coaxially with the valve core body, and the transmission part is configured to be fitted with a driving member to drive the valve core to move.

7. The electronic valve according to claim 6, wherein the valve core body has a connecting part and the transmission part comprises a plurality of gear teeth formed on the connecting part, and a gear acting as the transmission part is formed by the gear teeth and the connecting part.

8. The electronic valve according to claim 6, wherein the valve core body has a connecting part, the transmission part comprises a transition layer formed on the connecting part, and a plurality of gear teeth are formed on the transition layer, and a gear acting as the transmission part is formed by the gear teeth, the transition layer and the connecting part.

9. The electronic valve according to claim 6, wherein the transmission part is a gear.

10. The electronic valve according to claim 7, wherein the gear is a sector gear.

11. The electronic valve according to claim 6, wherein the valve core body is provided with a rotating shaft configured to be inserted into an external mounting portion, the rotating shaft at least partially overlaps with the transmission part in a first direction, and an accommodating part configured to accommodate the external mounting portion is formed between the rotating shaft and the transmission part, and the first direction is a radial direction of the valve core body.

12. The electronic valve according to claim 6, wherein two end portions of the valve core body in a second direction are a first end portion and a second end portion respectively, the transmission part is formed at the first end portion, a dustproof part is formed on the valve core body, the dustproof part is located between the transmission part and the second end portion, and the second direction is an axial direction of the valve core body.

13. The electronic valve according to claim 12, wherein the dustproof part is an annular structure provided coaxially with the valve core body, and the dustproof part has an outer diameter larger than that of the valve core body.

14. The electronic valve according to claim 13, wherein the dustproof part has a dustproof groove extending in a circumferential direction of the valve core body.

15. The electronic valve according to claim 14, wherein the dustproof groove has a groove opening facing an outside of the valve core body in a first direction, and the first direction is a radial direction of the valve core body.

16. The electronic valve according to claim 1, wherein the valve core comprises a valve core body and a gear, and the valve core body and the gear are integrally molded.

17. The electronic valve according to claim 16, wherein a top of the valve core body is provided with an annular groove.

18. The electronic valve according to claim 16, wherein an upper mounting shaft is provided at a top of the gear structure, and a lower mounting shaft is provided at a bottom of the valve core body.

19. The electronic valve according to claim 18, wherein at least one protruding rib is provided on a bottom end surface of the lower mounting shaft.

20. The electronic valve according to claim 16, wherein the valve core body is provided with a central through hole.
